(19) United States
(12) Patent Application Publication
(10) Pub. No.: US 2005/0065885 A1
(43) Pub. Date: Mar. 24, 2005

(54) ATM second personal identification number emergency response system

(76) Inventor: Michael Scott Gordon, Los Angeles, CA (US)

Correspondence Address: MICHAEL SCOTT GORDON, 4807 AMBROSE AVE., LOS ANGELES, CA, 90027, US

(21) Appl. No.: 10/668,163

(22) Filed: Sep. 24, 2003

(51) Int. Cl. G06F 17/60

(52) U.S. Cl. 705/43; 705/44

(57) ABSTRACT

Automatic Teller Machines (A.T.M.) will be equipped with the option of holding a second personal identification number (P.I.N.). This second personal identification number will give customers the opportunity to discreetly contact emergency authorities of crimes in progress. Users who successfully enter their second personal identification number will activate a communication device within the A.T.M. that will contact local authorities with the message that immediate help is requested. This empowers users to alert police without giving any indication to hostile strangers that such help is being requested. Activating the emergency response system through the use of the secondary personal identification number will also slow down the ATM machine enough to make a statistical difference in a crime in progress while being undetectable to most common day criminals.

### BACKGROUND OF THE INVENTION

Automatic Teller Machines (A.T.M.s) have been a revolutionary invention that offers bank customers twenty-four hour access to their deposits. However, these machines have opened the opportunity for lucrative thieves to wait for the right opportunity to coerce vulnerable customers to withdraw large sums of cash. Since these thieves are often not caught on videotape (some are wise enough to stand away from area under surveillance), customers are at risk of having substantial cash stolen. These customers are particularly vulnerable once they are confronted by their attacker since all means of contacting authorities (via cell phone, for instance) are curtailed by the attacker's watchful eye on the victim's actions.

Thus, because bank users are not able to contact public or private authorities during the commission of a crime, they are in danger of having substantial cash stolen and/or having substantial bodily injury imposed without the security of a patrol car on the way.

There have been several attempts to confront this pressing problem. Colbert (U.S. Pat. No. 5,594,806) attempts to fix this by having the computer camera focus on the knuckles of a user and thus allows for a form of identification of bank customers. While this may be useful for accurately identifying the bank user, it provides no security to bank users who are coerced by criminals to withdraw substantial cash that will be stolen after the bank transaction. Kroll (U.S. Pat. No. 6,062,474) also addresses this security lapse by proposing that A.T.Ms memorize the speed and nuances of each bank customer typing their P.I.N. and only accepting transactions that fit similar A.T.M. key-punched P.I.N. patterns of the respective bank customer. While this may successfully block unauthorized individuals from completing a transaction with a victim's ATM card, this does not empower each bank customer to individually contact security under dangerous circumstances.

A better method of A.T.M. security is by empowering each bank customer to take charge of their own safety by enabling them to create a second P.I.N. that will serve to be used exclusively to send the hidden message that emergency police protection is needed. This method relies on the ingenuity and accuracy of the bank customer to make the individual decision to contact security through their emergency P.I.N. rather than placing trust in the A.T.M. machine to detect suspicious activity, which is one of the weaknesses of Kroll's ATM security upgrade (U.S. Pat. No. 6,062,474). When customer uses their emergency P.I.N. there should not be any visual or audible confirmation of such a request. The A.T.M. should withdraw the amount requested by the customer to minimize potential confrontations between him/her and the criminal.

1. A method of allowing for an emergency response through use of an automatic teller machine compromising the steps of: maintaining a distinct personal identification number within an automatic teller machine that shall be used for emergency purposes; emergency personal identification number will have the same digits as a regular personal identification number but must be separate and distinct from customer's everyday use personal identification number transmitting, upon activation of second emergency personal identification number, to law enforcement personnel data on the need for an emergency response, which will indicate the following information automatic teller machine's location, time of day, amount of cash withdrawn, amount of cash deposited, or transferred, and any other transaction taken through the automatic teller machine; and to send a signal to the nearest financial branch office that an emergency personal identification number has been activated

2. The method of claim 1 (i.e., the activation of the emergency personal identification number) will activate a signal that alerts the automatic teller machine that an emergency personal identification number has been entered; and loads a distinct program for emergency systems that performs transactions, including deposits, withdrawals, transfers, at a slower rate through the use of, calculating the average time each transaction takes and using a standard deviation two times below the mean.
